(19) United States
(12) Patent Application Publication
(10) Pub. No.: US 2004/0029093 A1
(43) Pub. Date: Feb. 12, 2004

(54) Intelligent courseware development and delivery

(76) Inventor: Paul Guignard, Austin, TX (US)

Correspondence Address: GRAY, CARY, WARE & FREIDENRICH LLP, 1221 SOUTH MOPAC EXPRESSWAY, SUITE 400, AUSTIN, TX, 78746-6875, US

(21) Appl. No.: 10/380,298

(22) PCT Filed: Sep. 13, 2001
(86) PCT No.: PCT/AU01/01155

(30) Foreign Application Priority Data
Sep. 13, 2000 (AU) PR0090

(51) Int. Cl. G09B 19/00

(52) U.S. Cl. 434/365; 434/307 R

(57) ABSTRACT

The invention concerns a system for intelligent courseware development and delivery. It particularly involves a knowledge representation system having knowledge items expressed as respective mappings with multimedia explanations between patterns in a multidimensional problem space onto a multidimensional solution space. The problem and solution spaces form the context for the knowledge. Knowledge is accessed by consultations, where the user answers a question and the knowledge representation system uses the answer to automatically select another question. Items of course material are represented as respective knowledge items. Course elements are used to generate questions and tests semi-automatically in which the explanations can become the questions and the problem or source regions are presented to the learner as the options for the answers in multiple choice questions. The same model can be used for interactive learning games for individuals or groups of people.

### TECHNICAL FIELD

This invention concerns a system for intelligent courseware development and delivery.

### BACKGROUND ART

The process of producing pedagogically stimulating and effective multimedia courseware for delivery via the Internet or CD-ROM is time consuming and costly. Typically it takes weeks to months of work to produce a module that takes a learner about two hours to work through. This time factor (and its associated costs) limits the production of courseware to material that has a wide audience and that does not need frequent updating. The wide audience is needed to bring the cost per student to an acceptably low level, and the material needs to be stable because any change would be costly.

This situation is very unsatisfactory. Globalisation and the knowledge economy demand a workforce that is educated and that can update its knowledge on a continuous basis. In addition, the currently long production times do not enable organizations to react to new market situations quickly enough.

### SUMMARY OF THE INVENTION

The invention is a system for intelligent courseware development and delivery, comprising:

a knowledge representation system having knowledge items expressed as respective mappings with multimedia explanations between patterns in a multidimensional problem (or source) space onto a multidimensional solution (or destination) space, where the problem and solution spaces form the context for the knowledge, and knowledge is accessed by consultations where the user answers question(s) and the knowledge representation system uses the answers to automatically select other question(s); and where items of course material are represented as respective knowledge items.

From a practical viewpoint, the knowledge representation system makes it very effective to develop knowledge systems without any programming. The knowledge representation system makes it easy to:

define the source or problem space (the contexts) for expressing problems;

define the destination or solution space for expressing solutions;

link a subset of the problem space with a subset of the solution space (mapping);

explain the link with text and/or illustrations (multimedia environment);

access the knowledge in the system via a consultation (question-answer session).

The contexts are made of attributes, with each attribute having a type (list, logical, numerical, executable, and so on) a title, an explanation of its meaning (the explanation can be multimedia) and a set of values.

The definition of a knowledge item may involve specifying a type, giving a title, and specifying the problem region and, optionally, a solution region.

The problem region (or problem pattern) defines the applicability of the knowledge item; it is defined by a subset of the attributes in the problem context and their values. The solution region (or solution pattern) specifies (with the explanation) how the problem can be solved. It is defined by a subset of the attributes in the solution context and their values. In some cases knowledge items do not have a solution region, with the outcome of the problem being expressed by the explanation only.

Knowledge elements typically have a title, a category they belong to and, often, a super-category or module as higher classification. Typically, the elements are relatively small, that is, they can fit on one screen on a browser, for example.

The course (or knowledge) elements are usually presented in a separate window that is opened on the screen (alternatively, part of the existing window can be used). Each knowledge element, when displayed, shows a header with:

the title of the knowledge element;

the module and category it belongs to;

its level of difficulty or alternatively the level of difficulty for this particular student (based on a test);

whether it has already been seen or visited or studied by the user or learner;

whether it needs attention by the learner (this is based on test questions that have identified that this element was not adequately understood);

the type of material it is (e.g.: video, audio, text, list of things to do);

its learning mode.

This information, except the title of the course element and the module and category it belongs to, is usually presented in the form of icons. Underneath the header the system displays some or all of the following elements:

the body of the course element—this is the multimedia explanation about how the situation can be solved or dealt with;

other relevant information from the solution context if available—this is the list of the attributes that form the solution region and the values of these attributes;

when to use or apply this element (that is, the body of the element and any other information related to it)—this is the list of the attributes that form the problem or situation region and the values of these attributes;

the ‘See also’ links if they are available—these links take the user to information (other course elements or other information) that the trainer deems relevant to the material in the element;

an option to enter private comments about the elements being displayed—these comments and then linked to the course element and the user, and become available in the user's private folder;

an option to send feedback to the trainer about the course element being displayed.

Course elements may also be presented in views (see content exploration for example), that is, as a list underneath a category or module title. Here too, some information is displayed to give the learner some additional information about the courseware and his/her progress with it. The information being displayed next to each course element is:

the level of difficulty or alternatively the level of difficulty for this particular student (based on a test);

whether it has already been seen (or visited or studied) by the learner;

whether it needs attention by this learner (this is based on test questions that have identified that this element was not adequately understood);

its learning mode;

any other information.

A pre-learning test is designed to ascertain the competency level of the student before any new learning takes place. This information will tell the students whether the course elements are easy, challenging or very difficult for their current expertise levels.

A practice test enables students to access a set of questions and get a mark. This mark is then used to update the competency level, as determined by a previous pre-learning test or a previous practice test. The results are not communicated to the trainer.

An exam test functions as a practice test but the test results are communicated to the trainer.

A key aspect of test production is the re-use of the course elements. These elements are copied and then stored in another database or another table. These copied elements can be used as the basis for questions. Each element has a problem region (the subset of the problem space that defines what the element can be used for and/or relates to) that can form the basis of a question/answer by asking the learner to specify what application or situation or problem this course element is suitable for. In effect, the body or explanation of each course element can become the question, and the problem or source region is presented to the learner as the options for the answers in a multiple choice question.

The copied elements can be used in two ways.

The trainer checks that the explanation of the course element is understandable as a question and, if not, modifies it.

The trainer does as in a) and also modifies the problem region.

In the first case the trainer is satisfied with using the problem region as the options for the answer. In the second case, the trainer modifies the problem region, perhaps to make it more effective as a multiple choice question. In both cases, the marking of the test can be done automatically as the system can determine whether the student has specified, as an answer, a region that fits within the question region. If it does, the question has been answered successfully, if not, some more work may be required. The trainer can also use the solution regions instead of, or as a complement to, the problem regions, for the generation of choices available to students.

Using the course elements as the basis for questions establishes a link between the material in a course element and the question(s) that is derived from it. If the question is satifactorily answered then it may mean that the material has been absorbed and that the learner can perform at a satisfactory competency level with respect to the situation presented.

At run time, the system selects the questions randomly among the available questions (or takes them all if the available number is less than or equal to the desired number of questions in the test). Each time a test is selected, the questions are ordered randomly to minimize rote learning.

At the end of the test, the system computes the score and presents it to the learner with some advice about which material may need to be revised. The trainer can set the pass rate for each test

The test result can also be used to determine the student's competency level, for example, beginner, intermediate or advanced. The competency level for a module can be used to personalise the difficulty of the course elements in the module. The personal difficulty level is displayed next to, or with, every course element, typically with an icon.

Assignments, unlike questions, may require the trainer to check and grade the students' work. For convenience, assignments are stored in a separate database or table in the package. These assignments are designed not only to test the student but to teach as well. Their production and use involves statement of requirements to be presented to the student. The student then write a contribution and submit it. The system presents the student with examples of correct or appropriate statements and the student's first contribution in non-editable mode. The system invites the student to compare the previous contribution with the examples and, if desired, write an improved statement below the first contribution. The student submits the improved assignment to the system. The trainer inspects the student's work, marks it and forwards some feedback.

As can be seen in this sequence, the student learns through doing the assignment, even without participation by the trainer.

Other assignments can be produced in which a case or situation (that can cover several pages or screens) is presented to the learner who is then asked a series of questions about the situation and how to deal with it. These assignments can be graded automatically by the system.

Such assignments are constructed out of the elements already available in the system. The presentation of the situation is similar to the sequential presentation of course material in a module for example, and the series of questions corresponds to a test. It follows that the assignment can be constructed using the course element authoring technique and the test preparation described previously. This means that each screen or page in the assignment can have a source region attached to it that corresponds to the questions relevant to that part of the assignment presented on the page. Additional questions can be added, as described previously. At the end of the assignment, the system check the answers and the questions incorrectly answered can be used to point to the elements that need revision. The trainer may have the option of specifying the learning mode for each course element The learning mode may then be displayed as part of each element and in lists to tell the student the emphasis and type of presentation that can be expected. A students' preferred learning modes can be ascertained by a questionnaire.

The trainer can specify some parameters that define the way the system behaves. They include:

the parameters used to specify the behaviour of the knowledge representation system, such as: the maximum number of questions per secreen (first and subsequent screens), the maximum number of course or knowledge elements that can be presented per screen, the maximum number of times a question can be asked, the ordering of questions and their categories, the ordering of the knowledge elements and their categories);

the maximum number of questions per test;

the pass rate for the tests;

the lower rate for the intermediary competency level;

the lower rate for the advanced competency level.

The information captured by the system about the learner and its use of the system is used to provide the following feedback:

the learning mode in a course element and whether it matches that of the learner;

which course elements have been visited and which have not;

whether a module is ‘not started’, ‘in progress’ or ‘passed;’

whether a course element requires revision or attention.

In this way the invention is capable of producing intelligent courseware rapidly and at little cost.

The invention may provide an environment for Internet-based (network-based) courseware design and delivery. It addresses three important needs for the implementation of successful flexible learning systems: a) the need to produce stimulating and effective courseware quickly and at low cost; b) the need to deliver this courseware to learners in a way that fosters student participation, learning and material retention; and c) the need to update the courseware simply and quickly to reflect evolving requirements.

Benefits of examples of the invention include:

lower cost of course design, delivery, and maintenance;

improved capability for self-managed learning;

intelligent delivery of customized learning;

greater flexibility of access, modes of learning, and assessment.

easy update of the material and courseware.

Possibility to use the SYSTEM for dynamic scenario playing and interactive games.

The GKMS model underlying the ICDDE can also be used very effectively to support dynamic paths or scenarios within a knowledge base and also to support games. These two modes can be viewed independently of learning if desired but they can also be very useful for learning, either in a group or individually.

Dynamic scenarios refer to the users being offered choices at certain points in a story. The choice selected then determines what the next part of the story will be. Each page in the book is a knowledge item, with a source region that determines when it should be presented on the screen.

There are two possibiliites for the navigation.

1. The source region of each page is used to output the question.

2. The current state of the system (questions answered so far and path followed so far) determines which is the next question to ask.

Dynamic scenarios can be used to build simulations of complex systems and to help operators learn to manage these systems. A major advantage of building dynamic scenarios using the GKMS model is that the scenarios can be modified at any time, to reflect new training requirements, for example. Interactive games refer to games where the behaviour of the opponent is unpredictable (that is, there are no rules that the player knows the opponent follows to decide on his/her next move). This can be built using the GKMS model as follows:

1. A ‘game master’ sets the boundaries for the game. This is done by specifying the source context for the knowledge items (the destination context can also be included). In essence, the context provides the framework for the players to define their own rules and behaviours.

2. Each player can then define his/her behaviour. This is done by defining knowledge items. The source region of the knowledge item determines when the behaviour will be triggered during the game and the knowledge item explanation can be used to provide some description of the behaviour and perhaps its reason.

3. The game master can also define knowledge items that specify how the system reacts depending on what happens during the play.

The GKMS becomes the game master that manages and arbitrates the actions by the players. A human game master can also supervise the game and intervene with new knowledge items, some changes in the context, etc, as deemed appropriate.

Table 1 below expands on these benefits and Table 2 provides a comparison with ‘standard’ learning systems.

TABLE 1
features and benefits

| | Features | Benefits |
|---|---|---|
| 1. | Make learning material easy to | Produce more competent |
| | access and use and make the | knowledgeable and motivated |
| | learning process more flexible: | graduates in less time: |
| | Deliver self managed learning | Customize content and learning |
| | systems | modes to the needs of individual |
| | | students |
| | | Assess level of student |
| | | competency |
| | | Improve student motivation |
| | Test before, during, and after | Faster and more flexible learning |
| | the learning | process with flexible access |
| | Take students through chosen | |
| | learning path | |
| | Deliver learning material over | |
| | the internet | |
| | System based on sound | Effective learning outcome |
| | pedagogic models | |
| 2. | Reduce the cost of producing | New opportunities for learning |
| | learning systems: | systems where ‘standard’ |
| | | learning systems are too costly: |
| | No programming required to | Lower production costs |
| | produce material | |
| | Advanced methodologies to | Lower system implementation |
| | customize learning systems | costs |
| | Easy integration with existing | Efficient use of existing |
| | systems that contain learning | resources |
| | material | No expenditure on a new |
| | | training platform |
| 3. | Support addition and update of | Reduce the cost of maintaining |
| | knowledge without programming | learning systems, especially |
| | or re-design: | where knowledge evolves: |
| | Simple method of entering and | Learning can be based on the |
| | updating knowledge | latest available knowledge |
| | | Low maintenance costs |
| | | Record and makes explicit new |
| | | knowledge on an on-going basis |

TABLE 2
Comparison with ‘standard’ learning systems

| ‘Standard’ learning system | ICDDE |
|---|---|
| Static and limited ability to | Dynamically generates tests, |
| assess competency | during and after learning, to |
| | assess competency |
| Inability to identify optimum | Pre-tests to determine optimum |
| learning path | path through the course material |
| Superficial support of self- | Dynamically generates a variety |
| evaluation | of self-evaluation techniques |
| Manual and linear navigation | Dynamically generates non-linear |
| through course material | navigation and tracking through |
| | course material, adapted to the |
| | needs of each student |
| Static and limited advice about | Dynamically generates a wide |
| material and the best mode to | range of advice about the |
| learn it | material and the best mode to |
| | learn it, adapted to the needs of |
| | each student |
| Standard ‘take away’ course | Supports a personalized |
| notes provided at the end of the | ‘knowledge basket’ of material, |
| course | prioritized by students to their |
| | needs |

### BRIEF DESCRIPTION OF THE DRAWINGS

The invention will be described in a general way with reference to the following drawings:

FIG. 1 is block diagram showing the mappings between a problem space and a solution space.

FIG. 2 is functional diagram showing the brain's four quadrants.

FIG. 3a is a series of icons for compatability between the four brain quadrants and the learning modes, and FIG. 3b is a series of icons for incompatability between the four brain quadrants and the learning modes.

FIG. 4 is a graphical summary of the features of the invention.

An example of the invention will then be described with reference to the following drawings:

FIGS. 5 to 15 which are web pages which are displayed to users while using the invention.

### BEST MODES OF THE INVENTION

The ‘intelligent courseware development and delivery environment’ (ICDDE) treats courseware material as knowledge and uses a knowledge representation system that makes it easy to acquire knowledge and stimulating to access it. This knowledge representation system is described in the patent ‘Generic Knowledge Management System” (GKMS) patent application no PCT/AU99/00501).

This description shows how components based on and adapted from the GKMS patent, as well as other components, can be put together to create a dynamic and flexible learning environment. This description also includes elements of, and relies on, the patent on ‘Networked Knowledge Management And Learning’ (NKML), patent PR0852, and the patent on ‘Generic Knowledge Agents’ (GKA), patent PR2152.

The GKMS is a technology for knowledge acquisition, maintenance and processing. It is used commercially for the production of business solutions that embody knowledge in the form of ‘virtual advisors’ for example.

Practically, in virtual advisors, knowledge acquisition and knowledge maintenance must be possible without programming. This is essential to ensure that experts do not need intermediates (sometimes called knowledge engineers) to communicate with the knowledge systems. This immediacy is essential to secure the participation of domain experts. The set of requirements is shown in Table 1

TABLE 3
Necessary features for a virtual advisor for effective use of knowledge

| Features | Benefits |
|---|---|
| Ease of knowledge | Rapid development of knowledge |
| acquisition (without | systems |
| programming) | Participation by domain experts |
| Ease of knowledge | Knowledge can be adapted to changing |
| maintenance (without | circumstances |
| programming) | The knowledge systems can be |
| | populated as a function of the needs |
| | of users |
| Knowledge certification | Management of accountability and |
| process and audit trails | reward |
| | Management of quality and cultural |
| | issues |
| Knows the limit of its | System only gives advice approved by |
| knowledge | experts |
| | Can be used to trigger the acquisition |
| | of new knowledge when knowledge is |
| | missing |
| | System is safe to use |

The GKMS Knowledge Model

The GKMS model for knowledge representation comprises three parts: a) knowledge as mappings, b) knowledge is context dependent, and c) knowledge access is via consultations (or question-answer sessions).

Knowledge as Mappings

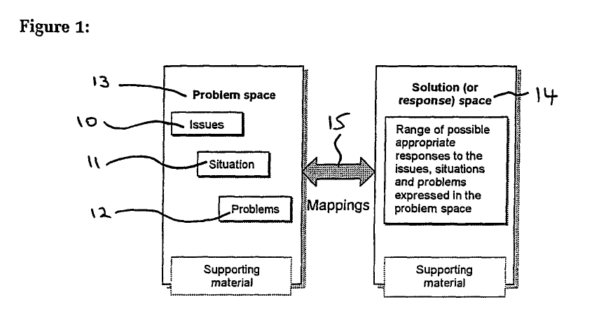

FIG. 1 illustrates the mapping process of the knowledge model. It is assumed here that knowledge is the ability to deal with issues 10, situations 11 and problems 12 that can be expressed in a problem space 13, and by knowing how to arrive at solutions for these issues, situations and problems. These solutions are part of the solution space 14. Thus knowledge can be expressed as mappings 15 between patterns in a multidimensional problem space 13 onto a multidimensional solution space 14. The two spaces (problem and solution) form the context for the knowledge expressed as mappings; it is the context of the knowledge system, sometimes called domain of discourse. The domain space can be modified at any time to suit new requirements for the system. The pattern in the solution space is the outcome of the mapping. A knowledge base is made of a multiplicity of mappings.

Knowledge as Context Dependent Mappings

It is clear that the mappings, which form the core of a knowledge base, are context dependent. If an attribute (or a dimension) is not part of the problem space of an expert, then this expert may not be able to express the problem at hand correctly or completely. For example, a mechanic who has no knowledge of lubricants may not be able to recognize or express a range of problems related to a car. In a similar way, it would prevent this so-called domain expert from providing the best solutions to lubricant-related problems. Therefore, the mappings provided by this expert would be of limited quality. In some cases they could be inadequate or perhaps even wrong.

From the above it is clear that the context (the problem and solution spaces) can determine the quality of the knowledge in a knowledge system. Non-experts who access knowledge systems often need to know what the contexts are that the experts have used. This is also the case when non-experts deal with human experts (seeking a second opinion relates mainly to exploring the context the experts have used as well as to making a subjective assessment of the quality of the mappings within these contexts). The above indicates that the context adopted by an expert, and reflected in the mappings created, plays a role in the quality of the knowledge expressed. The context must be explicit at knowledge acquisition time and, in many cases, it must be available to the users of that knowledge.

Knowledge Access via Consultations

The intuitive model for a consultation is a discussion with a senior colleague or expert in a domain. The key feature of a successful consultation session is that it leaves the user with specific answers to his/her questions and not, as is typical with search engines for example, with a list of materials to read, understand, interpret and then, if all goes well, apply correctly. The GKMS knowledge processing engine takes advantage of the knowledge representation model (based on the two spaces and the mappings) to implement and run a consultation (question-answer session). In this consultation, the user answers some questions that the GKMS uses to select the next best questions in order to arrive at the most relevant knowledge in the shortest possible number of questions.

The GKMS in use

From a practical viewpoint, the GKMS makes it very effective to develop knowledge systems without any programming. The GKMS makes it easy to:

1. define the source or problem space (the contexts) for expressing problems;

2. define the destination or solution space for expressing solutions;

3. link a subset of the problem space with a subset of the solution space (mapping);

4. explain the link with text and/or illustrations (multimedia environment);

5. access the knowledge in the system via a consultation.

The contexts are made of attributes, with each attribute having a type (list, logical, numerical, executable, and so on) a title, an explanation of its meaning (the explanation can be multimedia) and a set of values.

Points 1 to 4 support the creation of a knowledge-base with knowledge items in it. This is done without programming, using ‘point and click’ operations. The definition of a knowledge item involves specifying a type, giving a title, and specifying the problem region and, optionally, a solution region.

The problem region (or problem pattern) define the applicability of the knowledge item; it is defined by a subset of the attributes in the problem context and their values. The solution region (or solution pattern) specifies (with the explanation) how the problem can be solved. It is defined by a subset of the attributes in the solution context and their values. In some cases knowledge items do not have a solution region, with the outcome of the problem being expressed by the explanation only (point 4).

Point 5 is for the non-expert who need to access knowledge in a convenient way.

### ICCDE and the ‘Generic Knowledge Management System’

In this section we describe how the GKMS is used in the design of the ICDDE in order to produce the features and benefits mentioned in Table 1.

Competency-Based Learning

Competency-based learning is used here to explain the link between learning and the GKMS. It is, however, not the only way one can use the GKMS for developing learning packages and other pedagogical models can also be supported.

Competency-based learning teaches how to respond appropriately to situations. Learners, when competent, are expected to be able to respond according to a certain standard. Competency-based material links situations or problems to responses, and explains why these responses are appropriate for these problems. With respect to FIG. 1, in competency-based learning the situations correspond to the issues/situations/problems in the problem or source space in the GKMS, and the responses to patterns in the solution space and/or an explanation.

From the above, it follows that an element (or page) of the course material corresponds to a knowledge item in the GKMS, and the courseware material is made of a set of knowledge elements, called course elements. Knowledge elements typically have a title, a category they belong to and, often, a super-category or module as higher classification. Typically, the elements are relatively small, that is, they can fit on one screen on a browser, for example. This correspondence between the GKMS and competency-based learning means that the benefits of the GKMS for expressing knowledge without programming and accessing it interactively extend to the production and use of learning material.

Speed of Courseware Production and Maintenance

Learning material, made of a set of knowledge items or course elements (as in the GKMS), can be produced very quickly, at the fraction of the effort required by normal authoring tools. This material can be illustrated and enhanced with multimedia as desired. The material can be modified at any time without redesigning and/or retesting the whole course.

Authoring is carried out by trainers or lecturers, on the web using a browser. It can also be carried out in another environment, such as a Notes client in the Lotus-IBM Domino environment. The information required for each course element, in addition to the information specified above, is:

the module name;

the category (or sub-module) name;

the learning mode(s) that best describe the material;

the degree of difficulty of the element (elementary, challenging, more difficult).

The ‘See Also’ Facility

Trainers have the option, for each course element, to define a set of related course elements that the learner may find beneficial to read thoroughly. The trainer is presented, at course element definition time, with a list of possible ‘see also elements’. He/she can select some of them that become attached as links to the course element.

The list of ‘see also elements’ is made of all the course elements defined so far and of any other material that the trainer deems relevant. As new course elements are being defined, they are added automatically to the ‘see also list’. The ‘see also’ elements that are nor course elements as defined above must be added by the trainer.

Material Access by Learners

Access to the material in a course has to be pedagogically effective and stimulating. In current authoring environment, much time and effort is expended in making the material interactive (the navigation problem). This adds very significantly to the high cost of current courseware.

In contrast the ICDDE provides sophisticated material access mechanisms that come directly from using the GKMS to express the material in the courseware.

Interactive Discovery

The GKMS supports the consultation as access mechanism. In it, the GKMS presents some questions on the screen (usually combo-boxes with drop-down options). The user selects the options of interest and submits them to the system. The GKMS engine analyses the options submitted and, using its own ‘intelligence’ (cognitive processing) coupled with its awareness of the material available, presents the material that best matches the enquiry and asks further questions if the material cannot be precisely identified with the available information. The engine does this using the problem space (and sometimes the solution space) defined when the material was put into the system, and its knowledge of all the source regions or patterns associated with the course elements. Several such question-answer exchanges can take place during a consultation. The questions are seleced among the attributes in the source or questions space. This process enables users to find the material they are interested in as quickly as possible; it is essentially an interactive problem solving mechanism.

In the ICDDE, the mechanism above is used to enable learners to quickly identify the material they are interested in and wish to learn. This can be seen as a smart way of finding any relevant material in a large course, for example. The material retrieved is presented on the screen as titles (links) that, when clicked, typically, open an additional window (popup window) to show the knowledge element in question.

The interactive discovery process described above ‘bridges the gap’ between learning and on-the-job problem solving. That is, the material in the courseware can be accessed for learning (using the interactive discovery mode and the other access mechanisms described below) and for solving problems on-the-job. In the latter use, interactive discovery is used as a problem resolution mode that enables users to find solutions to problems quickly.

Contents Exploration

Content exploration corresponds to checking the table of contents in a book. In the ICDDE, the material is organised in modules which can contain categories which in turn contain course elements. When selecting this option, a learner can view the course modules, open one of them, view the categories in it and open a category to view the course elements in it. The user can then click on one of these elements to view it in a new window for example.

Smart Indexes

Smart indexes take advantage of the problem and solution contexts of the GKMS model used to express course elements. Course elements have a problem region (a subset of the problem context) and, optionally, a solution region (a subset of the solution context). The problem region of a knowledge element defines the sort of problems and situations the element is relevant to or can be applied to.

When a user clicks the smart index link or button, the system presents on the screen all the source context attributes that are associated with course elements. Typically, a context attribute has a title and some values (for example, the title could be ‘Fix a gear box problem in a car’ and the values could be ‘grinding noise’, ‘lost or broken gear’, ‘gear jumping out’, and so on). Next to each attribute title are the values that it can take and another column showing ‘All values’ or ‘Everything’. The values and ‘All values’ are links. When a user clicks a value the system presents all the course elements that have that value as part of their source regions. This means that the user has a very convenient way of finding all the course elements that relate to, for example, ‘grinding noise’ in a car gear box. By clicking on ‘All values’, the user gets to see all the course elements that relate to ‘Fix a gear box problem in a car’, whatever the problem.

A similar approach is taken with respect to the attributes and their values in the solution context.

Sequential Learning

Sequential learning refers to the presentation of the material in the order in which it has been organised by the trainer. This option takes the user through all the course elements in a module, for example. It minimises the initiative required of the learner in terms of material selection and order of learning of this material.

Each course element is shown in a window and the user can navigate to the next element or previous element (if available). When reaching the end of the module, the learner is informed that he or she can take a test on the material in the module.

The metaphor used in the different access modes described above is the ‘book metaphor’, selected because of its convenience and familiarity to all users.

View Course Elements that need Revision

As explained below, testing is used to identify the course elements that the learner needs to revise. The learner can select to view only these course elements. Access to these elements is via the mechanisms also described below.

Material Presentation

Course Elements

The course elements are usually presented in a separate window that is opened on the screen (alternatively, part of the existing window can be used). Each knowledge element, when displayed, shows a header with:

the title of the knowledge element; the module and category it belongs to;

its level of difficulty or alternatively the level of difficulty for this particular student (based on a test);

whether it has already been seen or visited or studied by the user;

whether it needs attention by this learner (this is based on test questions that have identified that this element was not adequately understood);

the type of material it is (e.g.: video, audio, text, list of things to do);

its learning mode.

This information, except the title of the course element and the module and category it belongs to, is usually presented in the form of icons. Underneath the header the system displays some or all of the following elements:

the body of the course element—this is the explanation about how the situation can be solved or dealt with;

other relevant information from the solution context if available—this is the list of the attributes that form the solution region and the values of these attributes;

when to use or apply this element (that is, the body of the element and any other information related to it)—this is the list of the attributes that form the problem or situation region and the values of these attributes;

the ‘See also’ links if they are available—these links take the user to information (other course elements or other information) that the trainer deems relevant to the material in the element;

an option to enter private comments about the elements being displayed—these comments and then linked to the course element and the user, and become available in the user's private folder;

an option to send feedback to the trainer about the course element being displayed.

View Presentation

Course elements are also presented in views (see content exploration for example), that is, as a list underneath a category or module title. Here too, some information is displayed to give the learner some additional information about the courseware and his/her progress with it. The information being displayed next to each course element is:

the level of difficulty or alternatively the level of difficulty for this particular student (based on a test);

whether it has already been seen (or visited or studied) by the learner;

whether it needs attention by this learner (this is based on test questions that have identified that this element was not adequately understood);

its learning mode;

any other information.

Modules

The course material is organised in modules (or chapters). In a similar way, the tests are designed to assess the learner's competency for each module. The information displayed for each module is whether the module has:

not been started;

is in progress—at least one course element in the module has been visited but the test not passed;

is passed—the test has been passed, whether some elements or all have been visited or not).

Testing and Assignments in the ICDDE

Testing

As for material presentation, the objective is to take advantage of the GKMS model to be able to generate tests quickly. Three types of tests are offered: pre-learning tests, practice tests and exam tests. Typically, each test relates to one module only.

A pre-learning test is designed to ascertain the competency level of the student before any new learning takes place. This information will tell the students whether the course elements are easy, challenging or very difficult for their current expertise levels.

A practice test enables students to access a set of questions and get a mark. This mark is then used to update the competency level, as determined by a pre-learning test or a previous practice test. The results are not communicated to the trainer.

An exam test functions as a practice test but the test results are communicated to the trainer.

Production of the Tests

Re-use of the Course Elements

A key aspect of test production is the re-use of the course elements. These elements are copied and then stored in another database or another table. The copying process can be under manual control (press ‘Copy’ button) or automated, with new course elements being added to the test database automatically. Each of these copied element can be used as the basis for a question. Indeed it is very convenient to do so as each element addresses a certain situation or problem that the learner must be able to deal with. In addition, each element has a problem region (the subset of the problem space that defines what the element can be used for and/or relates to). This can form the basis of a question by asking the learner to specify what application or situation or problem this course element is suitable for.

In effect, the body or explanation of each course element can become the question, and the problem or source region is presented to the learner as the options for the answers in a multiple choice question.

The copied elements can be used in two ways.

1. The trainer checks that the explanation of the course element is understandable as a question and, if not, modifies it.

2. The trainer does as in a) and also modifies the problem region.

In the first case the trainer is satisfied with using the problem region as the options for the answer. In the second case, the trainer modifies the problem region, perhaps to make it more effective as a multiple choice question. In both cases, the marking of the test can be done automatically as the GKMS can determine whether the student has specified, as an answer, a region that fits within the question region. If it does, the question has been answered successfully, if not, some more work may be required.

The trainer can also use the solution regions instead of, or as a complement to, the problem regions, for the generation of choices available to students.

Using the course elements as the basis for questions establishes a link between the material in a course element and the question(s) that is derived from it. If the question is satifactorily answered then it may mean that the material has been absorbed and that the learner can perform at a satisfactory competency level with respect to the situation presented.

There are other ways to use the course elements for producing questions. For example, one can present the problem or solution region pertaining to a course element and ask the student to provide the explanation for the course element. The trainer then has to evaluate the students answer.

Defining New Questions

The trainer can define new questions in the same way that course elements were entered (each question is a knowledge item according to the GKMS model). The explanation of the course element becomes the question and the problem/source region(s) the choices available as answers. The trainer is asked to associate each question with one or several course elements, in order to be able to point the learner to the topics that need reviewing if the question is not answered satisfactorily.

Other Question Types

A variety of choices can be offered the learner, such as ‘fill in the gap with a word or number’, ‘single choice in a set of multiple option’, ‘multiple choices in a set of multiple options’, and so on. They can all be supported using the GKMS model.

In ‘fill the gap with a word or number’ the learner is presented with a field to fill in with an answer. This answer is then compared with the members of the source/destination region of the course element used as question. If the filled in answer is a member of the region then the answer is deemed correct; if not, it is deemed incorrect.

In ‘single choice in a set of multiple option’, the learner can only give one answer even though more than one is correct according to the region attached to the element or question.

In ‘multiple choices in a set of multiple options’, the learner can select several choices as part of the answer. The system, under instruction from the trainer, then has to decide whether a) all the correct choices are needed to have a correct answer, b) whether some correct choices and no incorrect choices are sufficient, and c) whether some correct choices and some incorrect choices are also acceptable.

Test Generation

As for course elements, questions are organised in modules and categories. Tests can be defined for each module or category. The trainer can view all the questions in a hierarchical fashion (as in a file system) and can select which questions belong to which test for which module or category (a select box or equivalent next to the question title makes this possible). The trainer can also select the number of questions to be included in each test (this number does not need to be equal to the number of questions available in the module or category).

Taking a Test

At run time, the system selects the questions randomly among the available questions (or takes them all if the available number is less than or equal to the desired number of questions in the test). Each time a test is selected, the questions are ordered randomly to minimize rote learning.

Taking a test involves being presented with a series of questions, one at a time. The learner can skip questions, go back, and so on. If desired (this needs to be enabled by the trainer), learners can view the correct answer when each question is on the screen. The leaners can also view the answers at the end of the test, after the score has been calculated (leaners can view all answers or only the answers to the questions incorrectly answered).

At the end of the test, the system computes the score and presents it to the learner with some advice about which material may need to be revised. The trainer can set the pass rate for each test.

Test Marking

The tests can be marked automatically in all cases where the trainer uses a question region to specify the correct answer(s) to a question. This is because the GKMS can determine whether the student has specified, as the answer, a region that fits within (or is compatible with) the question region. If it does, the question has been answered successfully; if not, some revision work may be required by the student (used to give feedback). The processing for determining the correctness of answers is the same as the one used in the GKMS to ‘understand’ the enquiry so far in a consultation (see patent on GKMS); the same engine can be used.

Use of Test Results in the ICDDE

Module Level

At the module level, the test result determines whether the student has passed the module or not. This is used to provide feedback to the student, with an icon displayed on the screen, next to the module title.

The test result can also be used to determine the student's competency level, for example, beginner, intermediate or advanced. Whether the pass rate has been reached refers to an administrative requirement, the performance level refers to the learner's competency level. This is used at the course element level.

Course Element Level

The competency level for a module can be used to personalise the difficulty of the course elements in the module, as illustrated in the table 4 below.

TABLE 4
Personalizing the difficulty level of course elements

| | Course element | Personal or relative |
|---|---|---|
| Student's | difficulty level | course element |
| competency level | (absolute scale) | difficulty level |
| Beginner | Elementary | Challenging |
| | Challenging | More difficult |
| | (intermediate) | |
| | More difficult | Very difficult |
| Intermediate | Elementary | Elementary |
| | Challenging | Challenging |
| | (intermediate) | |
| | More difficult | More difficult |
| Advanced | Elementary | Very elementary |
| | Challenging | Elementary |
| | (intermediate) | |
| | More difficult | Challenging |

The personal difficulty level is displayed next to, or with, every course element, typically with an icon.

Marking gives information about the student's performance, the module being tested and about the individual course elements in the module that need to be revised (because of the association between test question and course element). This is used to give feedback to the student when the test score is calculated. In addition, the course elements related to the questions incorrectly answered by the learner are identified (with a ‘needs attention’ or ‘needs revision’ icon next to, or with every course element) so that the learner can quickly see which elements to revise or study.

Assignments

Assignments, unlike questions, may require the trainer to check and grade the students' work. For convenience, assignments are stored in a separate database or table in the package.

Assignments Graded by Trainer

These assignments are designed not only to test the student but to teach as well. Their production and use involves the following steps:

1. a statement of requirement is presented to the student (for example, write the mission statement for company x);

2. the student write his/her contribution and submits it to the system which puts it in the trainer's folder;

3. the system presents the student with examples of correct or appropriate statements (examples of good mission statements) and the student's first contribution in non-editable mode;

4. the system invites the student to compare his/her previous contribution with the examples and, if desired, write an improved statement below the first contribution;

5. when done the student submits the improved assignment to the system which puts it in the trainer's folder;

6. the trainer inspects the student's work, marks it and forwards some feedback if desired (the trainer can easily detect whether the student has simply tried to copy the examples given or whether some creative thinking—and therefore learning—has taken place between the student's first and second contributions).

As can be seen in this sequence, the student learns through doing the assignment, even without participation by the trainer.

Assignments Graded by the System

Such an assignment is one in which a case or situation (that can cover several pages or screens) is presented to the learner who is then asked a series of questions about the situation and how to deal with it.

The assignment is constructed out of the elements already available in ICDDE. The presentation of the situation is similar to the sequential presentation of material in a module, and the series of questions corresponds to a test. It follows that the assignment can be constructed using the material authoring technique described above and test preparation can be as described above. This means that each screen or page in the assignment can have a source region attached to it that corresponds to the questions relevant to that part of the assignment presented on the page. Additional questions can be added, as described previously.

As for tests, these assignments can be graded automatically by the system and the questions incorrectly answered can be used to point to elements that need revision.

Learning Modes and Their use in ICDDE

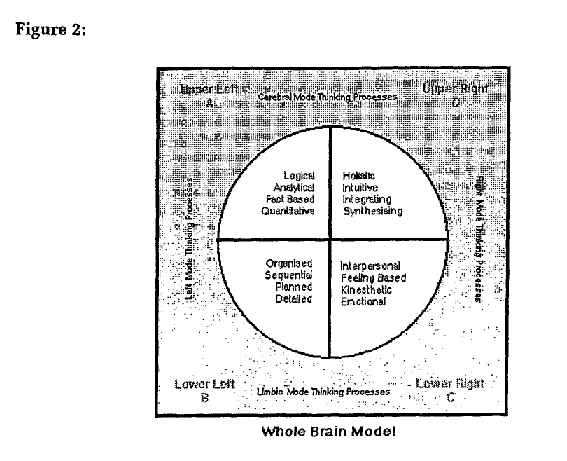

Psychologist describe the brain as being composed of four quadrants, each quadrant having certain characteristics with respect to the way it reacts to information and learns (see: http://www.ozemail.com.au/˜caveman/Creative/Brain/herrmann.htm, FIG. 2 and Table 5 below are taken from it).

TABLE 5
Quadrants, brain types and descriptions

| Quadrant | Type | Description |
|---|---|---|
| A | cerebra 1 | analytical, mathematical, technical and problem |
| | | solving |
| B | limbic | controlled, conservative, planned organised and |
| | | administrative in nature |
| C | limbic | interpersonal, emotional, musical, spiritual and |
| | | the “talker” modes |
| D | cerebra 1 | imaginative, synthesising, artistic, holistic and |
| | | conceptual modes |

The quadrants above are described as the learning modes of the brain.

Learning Modes and Course Elements

In ICDDE, the trainer has the option of specifying the learning mode for each course element. That is, the teacher is asked to identify the dominant learning mode present in each course element. The learning mode is displayed as part of each element and in lists to tell the student the emphasis and type of presentation that can be expected.

Learning Modes and Students

People are different from one-another. In learning, this is reflected by the preferred learning mode(s) for each individual. Most people are dominant in one or two quadrants, and people dominant in one quadrant are more receptive to material presented in the mode corresponding to that quadrant. In order to be able to take advantage of this feature, one needs to determine the preferrred learning modes of each student.

Finding the Students' Preferred Learning Modes

The students' preferred learning mode(s) can be ascertained by a questionnaire. The questions are typically defined by psychologists or teachers. The objective, at the end of the questionnaire, is to evaluate the set of answers and determine the preferred learning mode(s).

The learning mode questionnaire can be implemented in the same way that testing is implemented in the ICDDE. Unlike contents testing, the learning mode questionnaire is independent of the material in the courseware. Therefore it does not require frequent updates. It is typically implemented as a separate module in the ICDDE.

Use of the Students' Preferred Learning Modes in the ICDDE

What matters is to present the material to learners in the way that maximizes learning. As explained above, each courseware element has a learning mode. It is therefore important to give priority to these elements whose learning modes match the student's preferred learning mode(s).

When the same material is described in several elements, each using a different learning mode, then these elements with matching learning modes should can be presented first.

In many situations, the trainers do not have the time to produce several versions for each course element. In these situations, the ICDDE shows:

the student's learning mode and the course element's learning mode next to each other, as two icons; or

a single icon that indicates the course element's learning mode and whether it matches the student's learning mode.

In both situations, the learner can see whether the course element is presenting material that is ‘easiest’ for the student to relate to and understand.

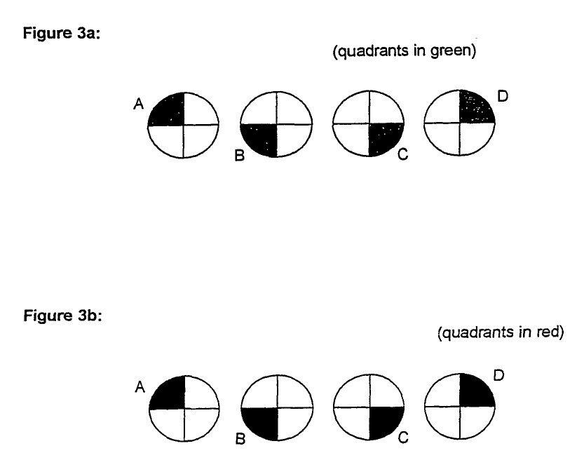

Some sample icons are shown in FIGS. 3a and 3b. In FIG. 3a, the presentation of the material in the course element is compatible with the student preferred learning mode. The quadrants for indicating the course element presentation mode are in green. In FIG. 3b, the presentation of the material in the course element is not compatible with the student preferred learning mode. The quadrants for indicating the course element presentation mode are in red.

Courseware Authoring and Management by Trainer or Lecturer

In addition to the creation of course elements, questions for the tests and assignments, the trainer can specify some parameters that define the way the ICDDE behaves. They include:

the parameters used to specify the behaviour of the GKMS (in Interactive discover, see GKMS patent, such as: the maximum number of questions per secreen (first and subsequent screens), the maximum number of course or knowledge elements that can be presented per screen, the maximum number of times a question can be asked, the ordering of questions and their categories, the ordering of the knowledge elements and their categories);

the maximum number of questions per test;

the pass rate for the tests;

the lower rate for the intermediary competency level;

the lower rate for the advanced competency level.

Using Knowledge About Course and Students to Provide Feedback

The objective is to give the learners and the trainers information and feedback that facilitate and stimulate learning. As explained previously, the ICDDE captures as much information as possible about the learner, its activites and competency level.

The information captured is:

the student's preferred learning mode(s);

the course elements visited;

the tests taken and the results obtained;

the questions answered incorrectly and the course elements to which they relate.

The information captured is used to provide the following feedback:

the learning mode in a course element and whether it matches that of the learner;

which course elements have been visited and which have not;

whether a module is ‘not started’, ‘in progress’ or ‘passed;’

whether a course element requires revision or attention.

A module is ‘not started’ if no course elements in it have yet been visited and if none of the tests have been taken. It is ‘in progress’ if some elements have been visited or one test taken. It is ‘passed’ if the exam test has been taken and the pass rate reached.

The information about modules is shown on all screens that display modules. The information about the course elements are shown on the screens that display lists of course elements, and in a course element when it is opened for display.

Assignments can be ‘done’ or ‘not done’ and their level of difficulty, as for course elements, can be entered by the trainer. This information is displayed on the screens that show lists of assignments and on the assignment themselves.

In addition, the ICDDE can track the progress of a group of students (students are identified and authenticated with a username and password). It can also display the performance and progress of each student with respect to the group he or she belongs to. This could be very useful as a motivating tool.

Other

ICDDE also supports a set of additional features.

Personal Annotation

Learners can click a ‘Personal annotation’ link on every course element. This opens a small window in which they can write personal comments about the course element. When submitted, the comments are attached or linked to (a copy of) the course element which is then put in the learner's personal folder, that is accessed from the browser.

Feedback or Comments from Learner to Trainer and Vice Versa

Learners can also click a ‘Comment to lecturer’ link on every course element. This opens a small window in which they can write comments for the lecturer or trainer. When submitted, the comments are attached or linked to (a copy of) the course element which is then forwarded to the lecturer's folder. A copy is also attached to the learner's personal folder for reference.

In a similar way, the lecturer can send comments to every student in a class. These comments are attached to each student's personal folder.

Add to Personal Folder

This option, when clicked, adds the course element to the learner's personal basket. No annotation is added to the course element.

Personal Folder

The personal folder is accessible from the browser's left navigator. When clicked, it shows its content in the main window at the right of the screen. The content is grouped in categories such as modules (contains the course elements that have annotations), messages from the lecturer, and so on. Alternatively, the content is presented as for ‘Content exploration’ and an icon is placed next to each element with a personal annotation.

Games and Other Learning and Discovery Mechanisms

The GKMS model underlying the ICDDE can also be used very effectively to support dynamic paths or scenarios within a knowledge base and also to support games. These two modes can be viewed independently of learning if desired but they can also be very useful for learning, either in a group or individually.

Dynamic Scenarios

Dynamic scenarios refer to the users being offered choices at certain points in a story. The choice selected then determines what the next part of the story will be. This is used in books for teenagers, for example, where their preferences determine the way the story develops and its eventual outcome. Below, we explain how dynamic scenarios can be built quickly using the GKMS model. We shall talk of dynamic books, even though we are referring to pages/screens accessible via a computer browser, for example.

Each page in the book is a knowledge item, with a source region that determines when it should be presented on the screen. On each page or screen, the reader is given the choice to continue or abort the story, or to decide what he/she would like to do next (or what a certain character or entity in the story should do, or will do, next).

The source region can include any choice that is supported by the story or pages in the book, such as:

how shall character/entity behave (it abandons, it selects the mountain path, it selects the valley path, and so on). Move to next page can also be an option.

There are two possibiliites for the navigation.

1. The source region of each page is used to output the question (as to what to do next) at the bottom of the page. In this case, the dynamic book is built like a decision tree and the GKMS model is used to implement it.

2. The current state of the system (questions answered so far and path followed so far) determines which is the next question to ask (this is the standard GKMS mode) which is then included in the page being viewed for the user to make a selection.

In the second case, the story writer simply states, in the region of each page, when it will be appropriate for the system to present this page on the screen. The path followed, that is the choices made by the user and the answers given so far, determine how the story will evolve next. This makes it possible to build richer dynamic stories than decision trees.

With reference to the GKMS model, the reader is having a consultation with the system, with the questions asked being selected dynamically and the answers used to decide which knowledge item(s) is relevant next The only difference with the standard GKMS is that the question(s) for deciding what happens next may be included inside the page being shown on the screen. In contrast, in the standard GKMS the questions appear on a separate ‘question-answer’ area on the screen that lists the questions and shows the relevant pages (answers/advice to the questions so far) as links that need to be clicked to open each page.

Dynamic scenarios can be used to build simulations of complex system and to help operators learn to manage these systems. For example, one can build a scenario that describes how a power plant behaves and how decisions by operators can impact the future performance of the plant and even how soon some components will break down.

A major advantage of building dynamic scenarios using the GKMS model is that the scenarios can be modified at any time, to reflect new training requirements, for example.

Interactive Games

Interactive games refer to games where the behaviour of the opponent is unpredictable (that is, there are no rules that the player knows the opponent follows to decide on his/her next move). An example of an interactive game could be the dynamic scenarios described above (the user does not know the rules, if any, the trainer/scenario builder has followed to build the story). A more interesting situation is one in which an arbitrary number of players can participate, each with their own agenda. This can be built using the GKMS model as follows:

1. A ‘game master’ sets the boundaries for the game. This is done by specifying the source context for the knowledge items (the destination context can also be included). In essence, the context provides the framework for the players to define their own rules and behaviours.

2. Each player can then define his/her behaviour. This is done by defining a knowledge item. The source region of the knowledge item determines when the behaviour will be triggered during the game and the knowledge item explanation can be used to provide some description of the behaviour and perhaps its reason.

3. Each player can define many knowledge items that describe their behaviour in a large variety of circumstances or situations during the game (players may have a limit on the number of knowledge items they can define).

4. The game master can also define knowledge items that specify how the system reacts depending on what happens during the play.

5. In essence, the players play against/with each other and against/with the system (as represented by the game master and its associated knowledge).

6. Players can enter new knowledge or edit their knowledge during the play to adapt to new situations created by the interactions of the players, the system and their behaviours and actions.

In essence, the GKMS becomes the game master that manages and arbitrates the actions by the players. A human game master can also supervise the game and intervene with new knowledge items, some changes in the context, etc, as deemed appropriate.

Implementation

All the software elements, objects and modules, icons, etc. can be implemented using knowledge elements that comply with the GKMS model, as explained in the GKA patent.

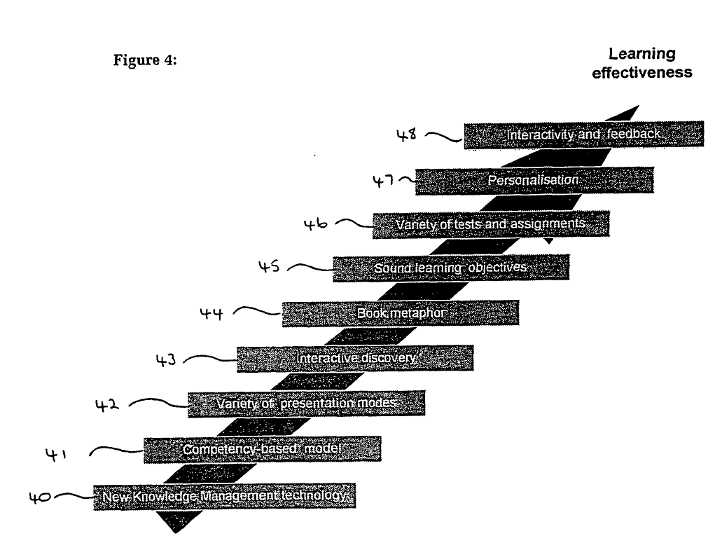

The description in the previous pages results in a courseware and learning system with a set of features and functionality that is summarised in FIG. 4. FIG. 4 shows how a new knowledge management technology 40 is built upon, first with a competency based model 41 then by a variety of presentation modes 42, interactive discovery 43, book metaphor 44, sound learning objectives 45, variety of tests and assignments 46, personalisation 47 and interactivity and feedback 48 to increase learning effectiveness.

This section describes an implementation of the ICDDE in the Lotus-IBM environment, using a Domino server. This implementation is for a pilot system being prepared for the University of Technology, Sydney; it reflects the desires of the lecturer involved. The figures below illustrate the important features mentioned in the previous sections. Other terminology and approaches could be used that would correspond to different teaching needs and that would be reflected in some aspects (links) on the left pane.

It is also possible to produce the ICDDE in a Java environment, using the techniques described in the previously-mentioned patents.

The ICDDE is the collection of the features described in the previous sections.

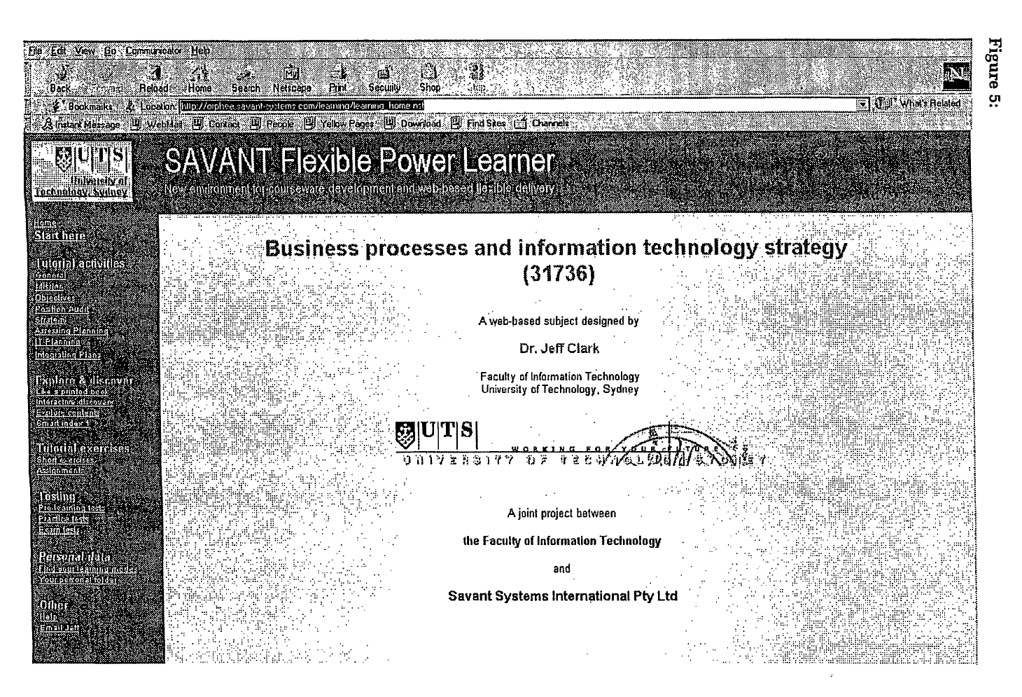

FIG. 5 is the home page for a demonstration subject concerning the University of Technology, Sydney. The left pane of the screen shows the list of tutorials (title can be changed) in the subject, the different ‘Explore and discover’ modes available, the tutorial exercies, the test available and the links giving access to personal data.

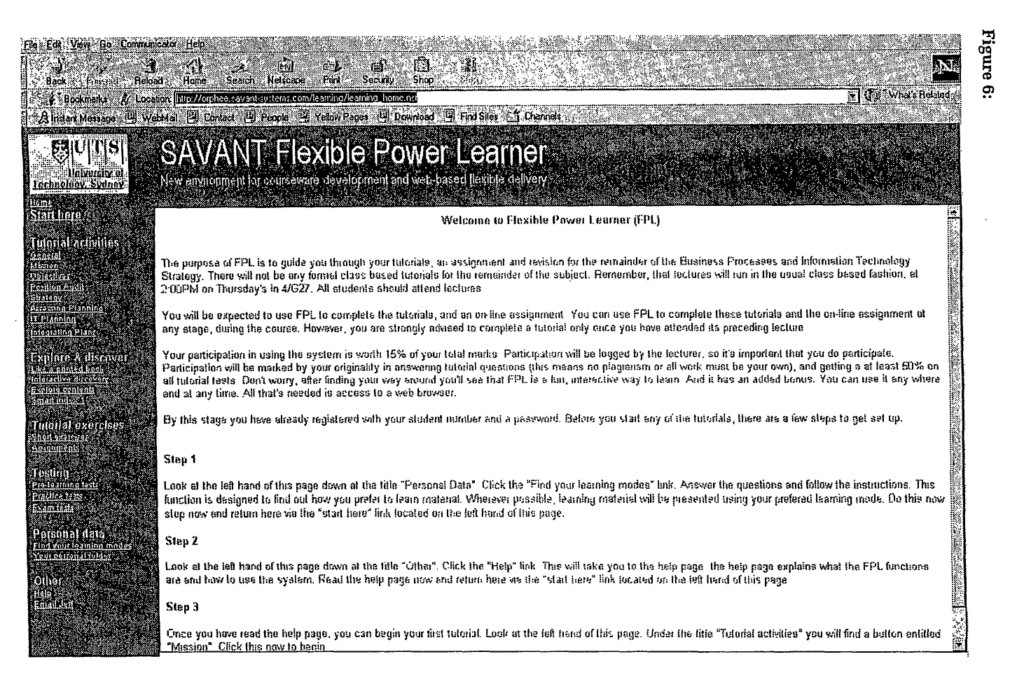

FIG. 6 shows the general instructions by the trainer on how to use the ICDDE and how the ICDDE-based activities fit into the flexible delivery of the subject.

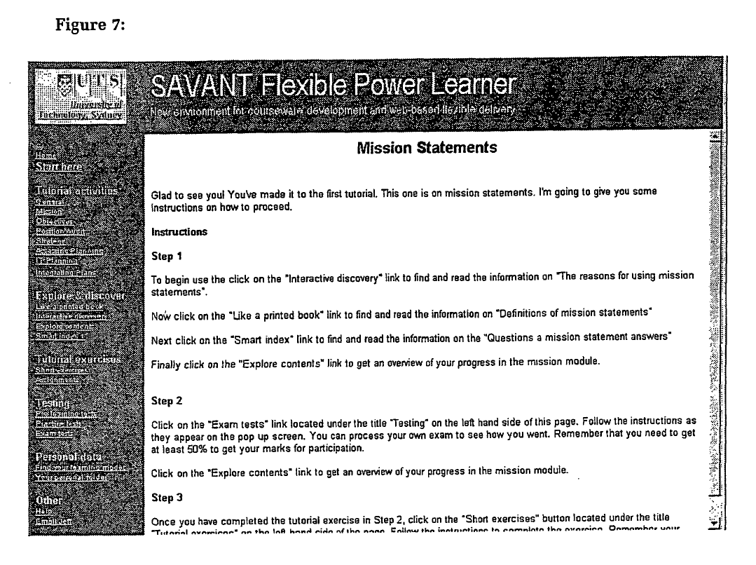

FIG. 7 shows the list of activities designed by the trainer for the ‘Mission’ module. Notice the links in the page to the selected left pane options.

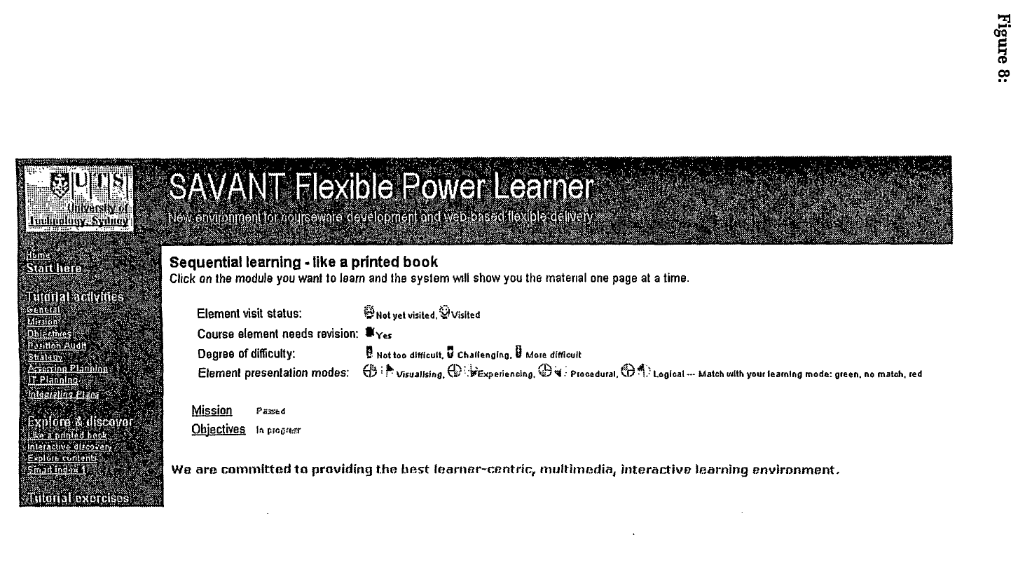

In FIG. 8 the right pane shows the ‘Like a printed book’ option. It shows the key for understanding the informtion and feedback, the list of modules available (mission and objectives) and the status of these modules (passed and in progress).

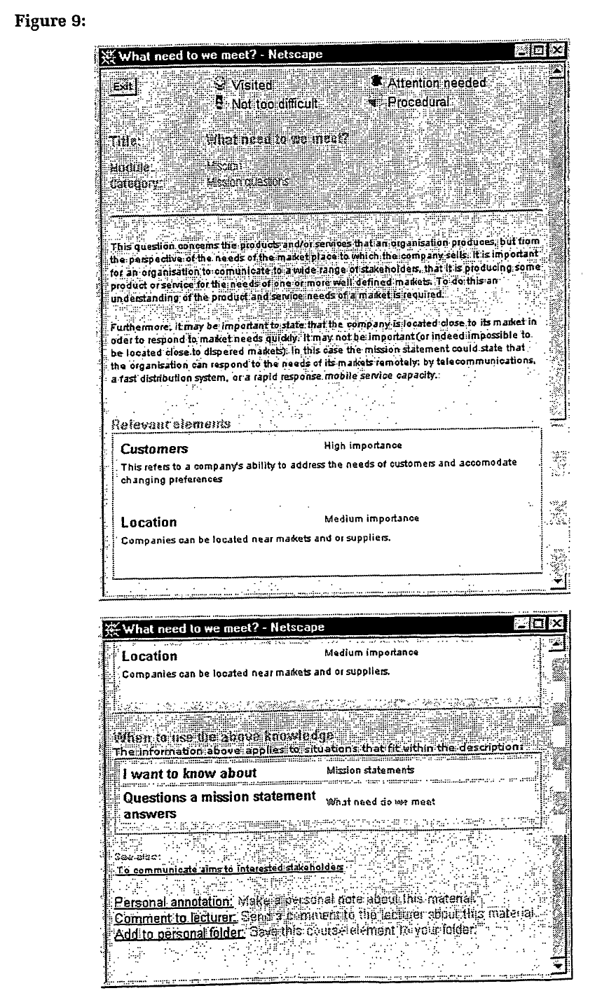

FIG. 9 shows the display of a course elements in the mission module. Notice the navigation buttons on the top (back and next), when to use the course element (given by the element problem region), the relevant elements (given by the element's solution region), the ‘see also’ links and, below, the ‘personal annotation’, the ‘comment to lecturer’ and the ‘add to personal folder’ links. These links open a new window with a text area for inputting the annotation or the comment, and a button to send the annotation to the personal folder or, if it is a comment for the trainer, to the the trainer.

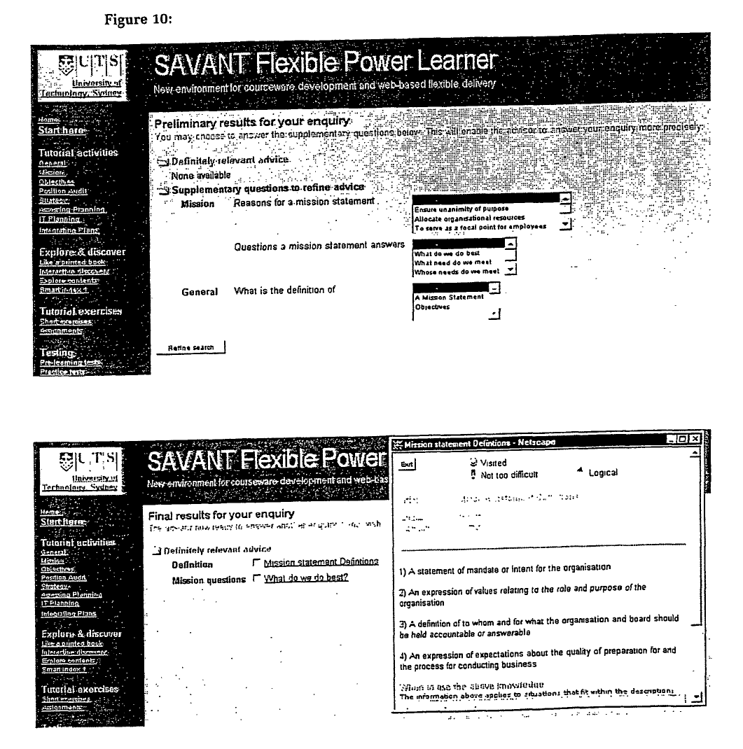

FIG. 10 shows an intermediate step in the ‘Interactive discovery’ process. The terminology is adapted to learning but the mechanism is the same as for the GKMS.

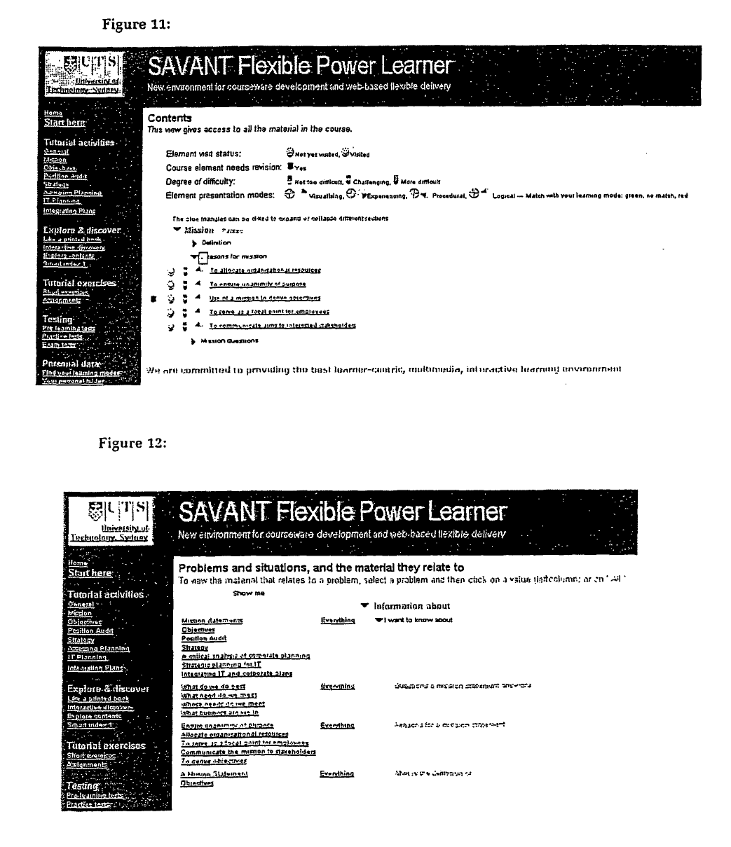

FIG. 11 illustrates the ‘Explore contents’ option. The user can open different modules (notice their status is displayed) and view the course elements in each of them (with the information and feedback icons).

In FIG. 12 the ‘Smart index’ shows the attributes or objects in the problem context and the values they can take. Clicking one value (left column) retrieves all the course elements that have attribute-value combinations in their problem regions. These course elements all have something to do with the attribute-value combination. If everything is clicked, second column from the left, only the attribute needs to be present in a course element to be retrieved (the value that this attribute has in the course element plays no role).

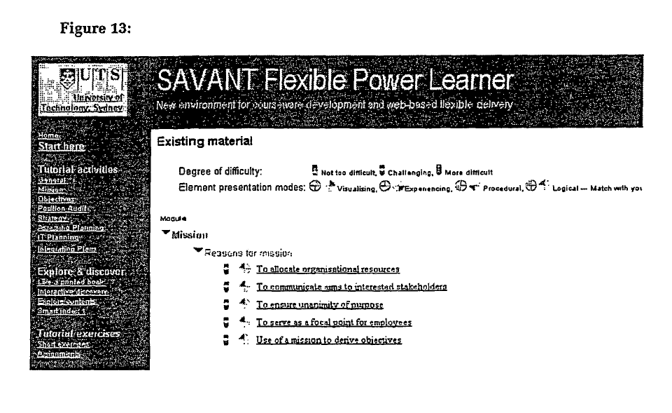

FIG. 13 shows a list of course elements retrieved after a user has clicked a value in the left column of a ‘Smart index’.

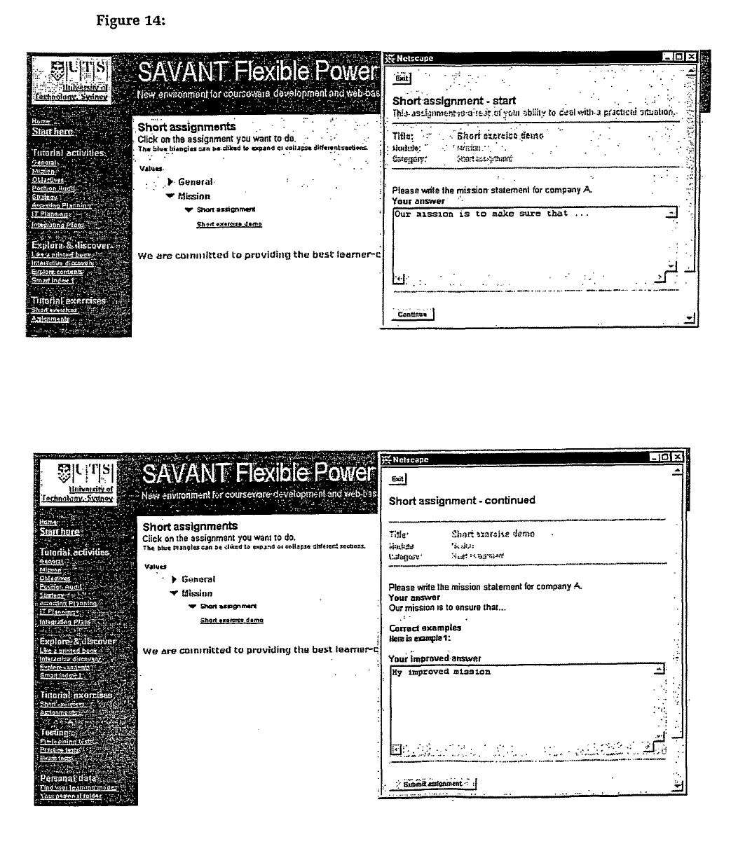

FIG. 14 shows the steps in a short assignment or exercise.

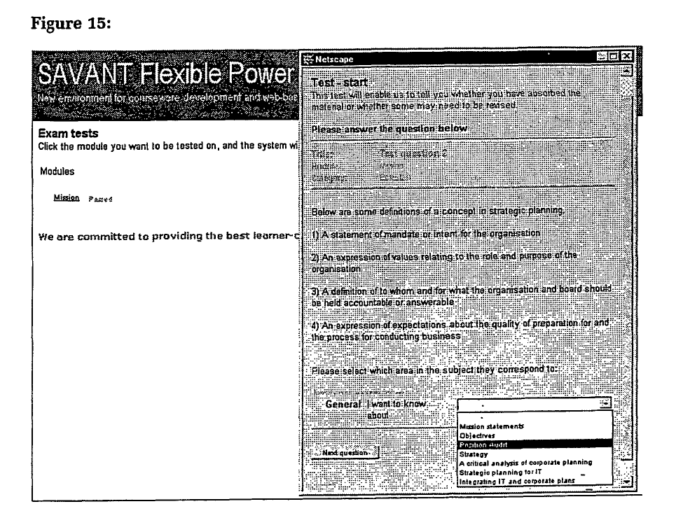

FIG. 15 shows a question in one of the tests available.

1. A system for intelligent courseware development and delivery, comprising:
a knowledge representation system having knowledge items expressed as respective mappings between patterns in a multidimensional problem space onto a multidimensional solution space, where the problem and solution spaces form the context for the knowledge, and knowledge is accessed by consultations where the user answers a question and the knowledge representation system uses the answer to automatically select another question; and where items of course material are represented as respective knowledge items.

2. A system according to claim 1, where the context is made of attributes, with each attribute having a type, a title, an explanation of its meaning and a set of values.

3. A system according to claim 1 or 2, where a knowledge item has a type, a title, a problem space and a solution space.

4. A system according to claim 2, where a subset of the problem space defines the applicability of a knowledge item; it is defined by a subset of the attributes in the context and their values.

5. A system according to claim 2, where a subset of the solution space specifies how a problem can be solved; it is defined by a subset of the attributes in the context and their values.

6. A system according to claim 2, where knowledge elements also have a category they belong to and, often, a super-category or module as higher classification.

7. A system according to claim 1, where knowledge elements are presented in a separate window that is opened on screen.

8. A system according to claim 7, where each knowledge element, when displayed, shows a header with some or all of the following information:
a title of the knowledge element;
a module and category it belongs to;
a level of difficulty or alternatively the level of difficulty for this particular student;
whether it has already been seen or visited or studied by the user;
whether it needs attention by this learner the type of material it is;
a learning mode.

9. A system according to claim 8, where the information, except the title of the course element and the module and category it belongs to, is presented in the form of icons.

10. A system according to claim 8 or 9, where underneath the header the system displays some or all of the following elements:
an explanation about how the situation can be solved or dealt with;
a list of the attributes that form the solution region and the values of these attributes;
a list of the attributes that form the problem or situation region and the values of these attributes;

11. A system according to claim 1, where knowledge elements are presented in views, that is, as a list underneath a category or module title.

12. A system according to claim 11, where information displayed next to each element is one or more of the following:
the level of difficulty or alternatively the level of difficulty for this particular student;
whether it has already been seen by the learner;
whether it needs attention by this learner;
a learning mode;

13. A system according to claim 1, where the system provides a pre-learning test designed to ascertain the competency level of the student before any new learning takes place.

14. A system according to claim 13, where the system provides a practice test to enable students to access a set of questions and get a mark; this mark is then used to update the competency level and the relative degree of difficulty of the course elements, as determined by a pre-learning test or practice test.

15. A system according to claim 14, where an exam test functions as a practice test but the test results are communicated to the trainer.

16. A system according to claim 14 or 15, where the system re-uses knowledge elements by copying and then storing them for use as the basis for a question.

17. A system according to claim 16 where each element has a problem region, a subset of the problem space, that forms the basis of a question/answer by asking the learner to specify what application or situation or problem this course element is suitable for.

18. A system according to claim 17, where copied knowledge elements can be used in two ways.
a trainer checks that the explanation of the course element is understandable as a question and, if not, modifies it; or
a also modifies the problem region.

19. A system according to any one of claims 13 to 18, where at run time, the system selects the questions randomly among the available questions.

20. A system according to any one of claims 13 to 18, where a test result can be used to determine a student's competency level which can then be used to personalise the difficulty of course elements in the module.

21. A system according to claim 1, where the system provides assignments which a trainer checks and grades.

22. A system according to claim 21, where the assignments are produced using one or more of the following steps:
a statement of requirement is presented to the student the student writes a contribution and submits it;
the system presents the student with examples of correct or appropriate statements and the student's first contribution in non-editable mode;
the system invites the student to compare the previous contribution with the examples and write an improved statement below the first contribution;

23. A system according to claim 1, where the system provides assignments where a case or situation is presented to a learner as a series of knowledge elements, and the learner is then asked a series of questions about the situation and how to deal with it, and these assignments are graded automatically by the system.

24. A system according to claim 23, where the assignments are constructed out of the elements already available in the system and presented sequentially, followed by a series of questions produced using a subset of the problem space of each element.

25. A system according to claim 1, where a trainer is able to specify the learning mode for each course element.

26. A system according to claim 25, where a learner's preferred learning mode is determined using a consultation.

27. A system according to claim 26, where each course element and a learners preferred mode and indicates whether or not they match.

28. A system according to claim 1, where a trainer is able to specify parameters that define the way the system behaves, they include:
parameters used to specify the behaviour of the knowledge representation system;
maximum number of questions per test; pass rate for a tests;
lower rate for an intermediary competency level;
lower rate for an advanced competency level.

29. A system according to claim 1, where information captured by the system about the learner and its use of the system is used to provide the following feedback:
a learning mode and whether it matches that of the learner;
which course elements have been visited and which have not;
whether a module is ‘not started’, ‘in progress’ or ‘passed;’
whether a course element requires revision or attention.

30. A system according to claim 1, where the system provides dynamic scenarios in which users are offered choices at certain points in a story, and the choice selected then determines what the next part of the story will be.

31. A system according to claim 30, where the source region of each page is used to output the question.

32. A system according to claim 30, where the questions answered so far and path followed so far determine which is the next question to ask.

33. A system according to claim 1, where the system provides interactive games where the behaviour of the opponent is unpredictable.

34. A system according to claim 33, where a ‘game master’ sets the boundaries for the game by specifying the source context for the knowledge items and the destination context to provide a framework for the players to define their own rules and behaviours.

35. A system according to claim 33, where each player defines their own behaviour by defining knowledge items, and the source space of the knowledge item determines when the behaviour will be triggered during the game and a knowledge item explanation can be used to provide some description of the behaviour and perhaps its reason.
